(19) United States
(12) Patent Application Publication
(10) Pub. No.: US 2022/0255501 A1
(43) Pub. Date: Aug. 11, 2022

(54) Flexible Ground Path Connector

(71) Applicant: Brantingham and Carroll Holdings, Inc., Leetsdale, PA (US)

(72) Inventors: Matthew P. Carroll, Leetsdale, PA (US); James A. Carroll, Aiken, SC (US); Marvin Hochstedler, Melipilla (CL); Soren Jensen, Corte Madera, CA (US); Aaron Michael Spindell, Fairfax, CA (US); José Miguel Tomicic Müller, Santiago (CL)

(21) Appl. No.: 17/665,835

(22) Filed: Feb. 7, 2022

Related U.S. Application Data
(60) Provisional application No. 63/146,979, filed on Feb. 8, 2021.

(51) Int. Cl. H02S 40/34

(52) U.S. Cl. CPC H02S 40/34

(57) ABSTRACT

A flexible ground path connector for a photovoltaic module system, the flexible ground path connector including a body, a first attachment portion provided on a first end of the body, and a second attachment portion provided on a second end of the body, the second end of the body opposing the first end of the body, wherein at least the body is made of a substantially flexible material, and wherein the first attachment portion is configured to attach to a first photovoltaic module rack and the second attachment portion is configured to attach to a second photovoltaic module rack.

### CROSS REFERENCE TO RELATED APPLICATION

This application claims benefit of priority from U.S. Provisional Patent Application No. 63/146,979, filed Feb. 8, 2021, the contents of which is incorporated herein by reference in its entirety.

### BACKGROUND OF THE INVENTION

### Field of the Invention

The present disclosure is directed to a photovoltaic module system and, more particularly, to a ground path connector for the photovoltaic module system.

### Description of Related Art

Currently, solar racking systems include a plurality of independent photovoltaic module tables arranged in rows. A current problem facing the industry when using independent tables is that all tables in a row must be electrically tied or bonded together for grounding purposes. Further, the interconnecting photovoltaic wiring must be run along a length of each row. Therefore, bundles of power wiring must bridge from table to table. The ends of adjacent tables cannot be perfectly lined up due to variable grades and construction tolerances. Therefore, when bridging from table to table, wiring can come into contact with sharp metal edges. In addition, the tables are subject to vibration, wind, seismic, and other variable forces. These forces cause relative motion between adjacent tables, which puts local stress on the wires. Wires in contact with metal edges and subject to variable forces and vibration can easily lead to wire failure. Wire failure not only causes loss of power production, but with voltages up to 1500 V, this also represents a personnel safety hazard.

A further problem in the current industry is the appearance of independent tables. Discontinues between the ends of adjacent tables can be interpreted as unacceptable misalignment by some customers. Therefore, there are several different problems with current solar racking systems that need to be addressed and obviated.

### SUMMARY OF THE INVENTION

In one embodiment, a ground path connector for a photovoltaic module system is provided. The ground path connector may include a body, a first attachment portion provided on a first end of the body, and a second attachment portion provided on a second end of the body, the second end of the body opposing the first end of the body, wherein at least the body is made of a substantially flexible material, and wherein the first attachment portion is configured to attach to a first photovoltaic module arrangement and the second attachment portion is configured to attach to a second photovoltaic module arrangement.

In another embodiment, a photovoltaic module system is provided. The photovoltaic module system may include a first photovoltaic module arrangement, a second photovoltaic module arrangement, and a ground path connector, the ground path connector may include a body, a first attachment portion provided on a first end of the body, and a second attachment portion provided on a second end of the body, the second end of the body opposing the first end of the body, wherein at least the body is made of a substantially flexible material, and wherein the first attachment portion is configured to attach to the first photovoltaic module arrangement and the second attachment portion is configured to attach to the second photovoltaic module arrangement.

Various aspects of the present disclosure may be further characterized by one or more of the following clauses:

Clause 1: A ground path connector for a photovoltaic module system, the flexible ground path connector comprising a body, a first attachment portion provided on a first end of the body, and a second attachment portion provided on a second end of the body, the second end of the body opposing the first end of the body, wherein at least the body is made of a substantially flexible material, and wherein the first attachment portion is configured to attach to a first photovoltaic module arrangement and the second attachment portion is configured to attach to a second photovoltaic module arrangement.

Clause 2: The ground path connector of clause 1, wherein the body is a radiused shape.

Clause 3: The ground path connector of clause 1 or 2, wherein the radiused shape is a round radius, a W-shaped contour, a U-shaped contour, an omega-shaped contour, or a combination thereof.

Clause 4: The ground path connector of any of clauses 1 to 3, wherein the radiused shape is a round radius.

Clause 5: The ground path connector of any of clauses 1 to 4, wherein the radiused shape is a W-shaped contour.

Clause 6: The ground path connector of any of clauses 1 to 5, wherein the radiused shape is a U-shaped contour.

Clause 7: The ground path connector of any of clauses 1 to 6, wherein the radiused shape is an omega-shaped contour.

Clause 8: The ground path connector of any of clauses 1 to 7, wherein the first attachment portion or the second attachment portion is substantially round.

Clause 9: The ground path connector of any of clauses 1 to 8, wherein the first attachment portion and the second attachment portion are substantially round.

Clause 10: The ground path connector of any of clauses 1 to 9, wherein the body comprises a middle portion between the first attachment portion and the second attachment portion.

Clause 11: The ground path connector of any of clauses 1 to 10, wherein the middle portion is offset on a horizontal axis from the first attachment portion and the second attachment portion.

Clause 12: The ground path connector of any of clauses 1 to 11, wherein the middle portion comprises one or more holes configured for a wire management system.

Clause 13: The ground path connector of any of clauses 1 to 12, wherein the middle portion comprises two holes configured for a wire management system.

Clause 14: The ground path connector of any of clauses 1 to 13, wherein the first attachment portion or the second attachment portion comprises one or more holes for attaching to the first photovoltaic arrangement and the second photovoltaic arrangement, respectively.

Clause 15: The ground path connector of any of clauses 1 to 14, wherein the first attachment portion and the second attachment portion comprises one or more holes for attaching to the first photovoltaic arrangement and the second photovoltaic arrangement, respectively.

Clause 16: The ground path connector of any of clauses 1 to 15, wherein the flexible material is selected from the group consisting of steel, aluminum, metal, elastomer, corrugated material, a plastically deformable material, and a combination thereof.

Clause 17: The ground path connector of any of clauses 1 to 16, wherein the flexible material is steel.

Clause 18: The ground path connector of any of clauses 1 to 17, wherein the flexible material is aluminum.

Clause 19: The ground path connector of any of clauses 1 to 18, wherein the flexible material is metal.

Clause 20: The ground path connector of any of clauses 1 to 19, wherein the flexible material is elastomer.

Clause 21: The ground path connector of any of clauses 1 to 20, wherein the flexible material is a corrugated material.

Clause 22: The ground path connector of any of clauses 1 to 21, wherein the flexible material is a plastically deformable material.

Clause 23: The ground path connector of any of clauses 1 to 22, wherein the steel is thin gauge steel, a pre-galvanized steel, or a commercial grade steel.

Clause 24: The ground path connector of any of clauses 1 to 23, wherein the steel is thin gauge steel.

Clause 25: The ground path connector of any of clauses 1 to 24, wherein the steel is a pre-galvanized steel.

Clause 26: The ground path connector of any of clauses 1 to 25, wherein the steel is a commercial grade steel.

Clause 27: The ground path connector of any of clauses 1 to 26, wherein the metal is a conductive metal.

Clause 28: The ground path connector of any of clauses 1 to 27, wherein the elastomer is a natural or synthetic polymer having elastic properties.

Clause 29: The ground path connector of any of clauses 1 to 28, wherein the elastomer is a natural polymer having elastic properties.

Clause 30: The ground path connector of any of clauses 1 to 29, wherein the elastomer is a synthetic polymer having elastic properties.

Clause 31: The ground path connector of any of clauses 1 to 30, wherein the elastomer is bonded to a metal strip, optionally a thin metal strip.

Clause 32: The ground path connector of any of clauses 1 to 31, wherein the elastomer is bonded to a thin metal strip.

Clause 33: A photovoltaic module system comprising a first photovoltaic module arrangement, a second photovoltaic module arrangement, and a ground path connector, the ground path connector comprising a body, a first attachment portion provided on a first end of the body, and a second attachment portion provided on a second end of the body, the second end of the body opposing the first end of the body, wherein at least the body is made of a substantially flexible material, and wherein the first attachment portion is configured to attach to the first photovoltaic module arrangement and the second attachment portion is configured to attach to the second photovoltaic module arrangement.

Clause 34: The photovoltaic module system of clause 33, wherein the body is a radiused shape.

Clause 35: The photovoltaic module system of clause 33 or 34, wherein the radiused shape is a round radius, a W-shaped contour, a U-shaped contour, an omega-shaped contour, or a combination thereof.

Clause 36: The photovoltaic module system of any of clauses 33 to 35, wherein the radiused shape is a round radius.

Clause 37: The photovoltaic module system of any of clauses 33 to 36, wherein the radiused shape is a W-shaped contour.

Clause 38: The photovoltaic module system of any of clauses 33 to 37, wherein the radiused shape is a U-shaped contour.

Clause 39: The photovoltaic module system of any of clauses 33 to 38, wherein the radiused shape is an omega-shaped contour.

Clause 40: The photovoltaic module system of any of clauses 33 to 39, wherein the first attachment portion or the second attachment portion is substantially round.

Clause 41: The photovoltaic module system of any of clauses 33 to 40, wherein the first attachment portion and the second attachment portion are substantially round.

Clause 42: The photovoltaic module system of any of clauses 33 to 41, wherein the body comprises a middle portion between the first attachment portion and the second attachment portion.

Clause 43: The photovoltaic module system of any of clauses 33 to 42, wherein the middle portion is offset on a horizontal axis from the first attachment portion and the second attachment portion.

Clause 44: The photovoltaic module system of any of clauses 33 to 43, wherein the middle portion comprises one or more holes configured for a wire management system.

Clause 45: The photovoltaic module system of any of clauses 33 to 44, wherein the middle portion comprises two holes configured for a wire management system.

### BRIEF DESCRIPTION OF THE DRAWINGS

The novel features described herein are set forth with particularity in the appended claims. Such features, however, both as to organization and methods of operation, may be better understood by reference to the following description, taken in conjunction with the accompanying drawings.

FIGS. 1A and 1B are perspective views of a ground path connector according to some examples of the present disclosure;

FIG. 1C is a side view of the ground path connector of FIGS. 1A and 1B;

FIG. 1D is a top view of the ground path connector of FIGS. 1A-1C;

FIG. 2A is a perspective view of a ground path connector according to one example of the present disclosure;

FIG. 2B is a side view of the ground path connector of FIG. 1A;

FIG. 2C is a top view of the ground path connector of FIGS. 1A and 1B;

FIG. 3A is a perspective view of a photovoltaic module system with a ground path connector according to one example of the present disclosure; and

FIG. 3B is a side view of the photovoltaic module system of FIG. 3A.

### DESCRIPTION OF THE DISCLOSURE

In the following detailed description, reference is made to the accompanying drawings, which form a part hereof. The illustrative features shown and described in the detailed description, drawings, and claims are not meant to be limiting. Other features may be utilized, and other changes may be made, without departing from the scope of the subject matter presented here.

Before describing the various aspects of the ground path connector and various features thereof in detail, it should be noted that the various aspects disclosed herein are not limited in their application or use to the details of construction and arrangement of parts illustrated in the accompanying drawings and description. Rather, the disclosed devices may be positioned or incorporated in other devices, variations, and modifications thereof, and may be practiced or carried out in various ways. Accordingly, aspects of the ground path connector disclosed herein are illustrative in nature and are not meant to limit the scope or application thereof. Furthermore, unless otherwise indicated, the terms and expressions employed herein have been chosen for the purpose of describing the various aspects of the ground path connector features for the convenience of the reader and are not to limit the scope thereof. In addition, it should be understood that any one or more of the components of the ground path connector features, expressions thereof, and/or examples thereof, can be combined with any one or more of the other components, expressions thereof, and/or examples thereof, without limitation.

For purposes of the description hereinafter, spatial orientation terms, as used, shall relate to the referenced aspect as it is oriented in the accompanying drawings, figures, or otherwise described in the following detailed description. However, it is to be understood that the aspects described hereinafter may assume many alternative variations and configurations. It is also to be understood that the specific components, devices, features, and operational sequences illustrated in the accompanying drawings, figures, or otherwise described herein are simply exemplary and should not be considered as limiting.

Also, in the following description, it is to be understood that terms such as front, back, inside, outside, top, bottom, and the like are words of convenience and are not to be construed as limiting terms. Terminology used herein is not meant to be limiting insofar as devices described herein, or portions thereof, may be attached or utilized in other orientations. The various aspects of the photovoltaic module arrangement features will be described in more detail with reference to the drawings.

“About” as used herein means ±10% of the referenced value. In certain embodiments, “about” means ±9%, or ±8%, or ±7%, or ±6%, or ±5%, or ±4%, or ±3%, or ±2% or ±1% of the referenced value.

The present disclosure is directed to the use of a flexible ground path connector which will serve several purposes in overcoming issues identified in the current industry. As shown in the figures described below, according to embodiments of the present disclosure, the flexible ground path connector provides an electrical grounding path between adjacent photovoltaic module tables. The flexible ground path connector also provides protection for the cable bundle against the edges of the beams of each photovoltaic module table as the cable bundle crosses from one table to another. Since the photovoltaic module racks are not connected structurally, the photovoltaic module racks will often move independently of each other in all three axis, x, y, and z. The flexibility of the present ground path connector allows for slight misalignment between adjacent solar racking tables and allows for differential movement (due to wind or other external forces) in all directions without fatigue or failure. The flexibility of the present ground path connector also allows for a user or installer to shape or mold the ground path connector in all three axis, thus allowing the user or installer to stretch, bend, or conform the ground path connector in a manner suitable for connecting adjacent photovoltaic module tables.

The ground path connector of the present disclosure also improves an alignment of a row of the photovoltaic module tables. When disconnected, the photovoltaic module tables are arranged in a row. Slight differences in position between adjacent photovoltaic module tables present a potential problem. The discontinuity between photovoltaic module tables in a row is often perceived as a defect by the owner of a solar system. The flexible ground path connector of the present disclosure improves the differences and inconsistencies between photovoltaic module tables, thereby minimizing the discontinuities and resulting in a smoother, more continuous row of photovoltaic module tables.

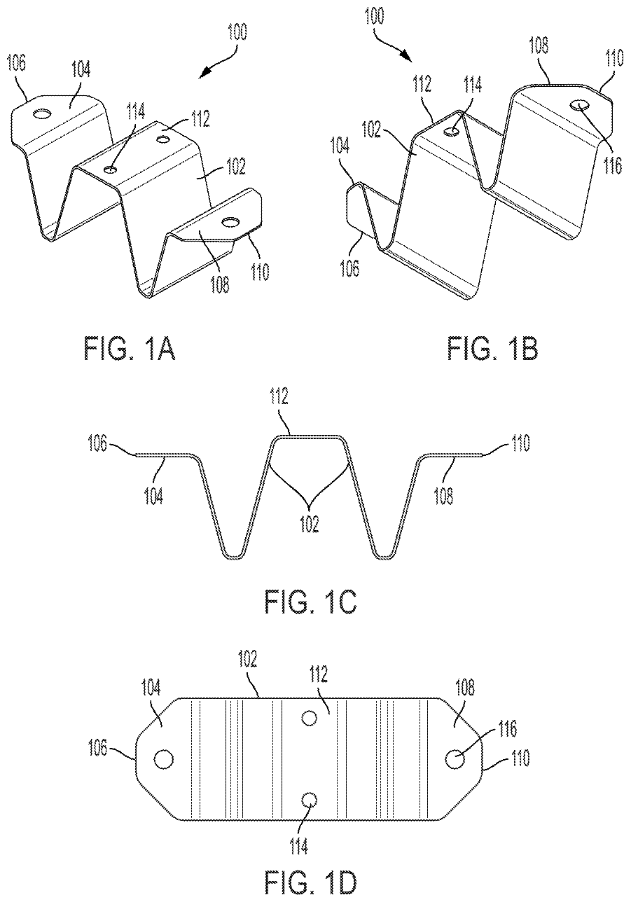

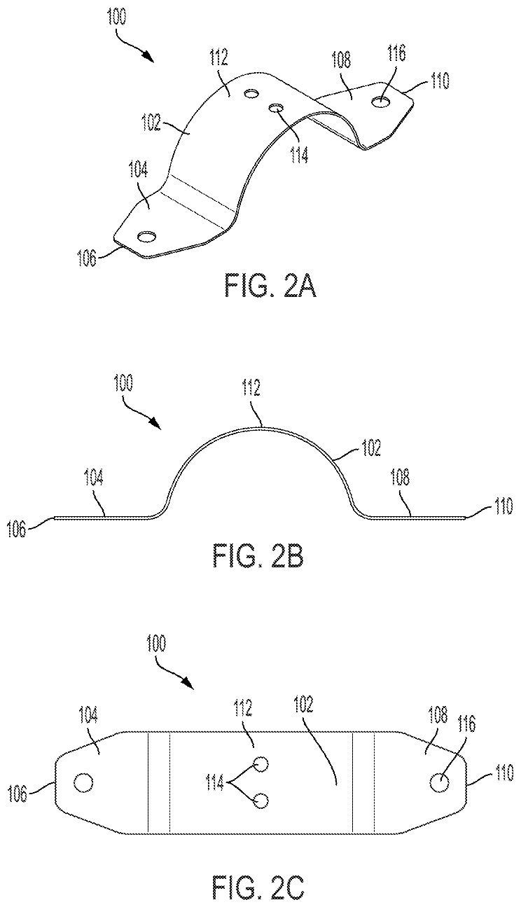

As shown in FIGS. 1A-2C, the present ground path connector (100) for a photovoltaic module system may include, in one non-limiting example of the present disclosure, a body (102), a first attachment portion (104) provided on a first end (106) of the body (102), and a second attachment portion (108) provided on a second end (110) of the body (102). In some embodiments, the second end (110) of the body (102) may oppose the first end (106) of the body (102). In some embodiments, the body (102) of the ground path connector (100) can be a radiused shape. In a particular embodiment, the body (102) of the ground path connector (100) can be a radiused shape having a W-shaped contour as illustrated in FIGS. 1A-1C. In further embodiments, the body (102) of the ground path connector (100) can be a radiused shaped having a U-shaped contour or an omega-shaped contour as depicted in FIGS. 2A and 2B. Further, and as illustrated in FIGS. 1A-2C, the first attachment portion (108) or the second attachment portion (112) can be substantially round. It is to be understood that the various radiused shapes of the ground path connector (100) allow for relative motion between the ends of two photovoltaic module arrangements.

In some non-limiting embodiments, the body (102) can be made of a substantially flexible material. In some embodiments, the flexible material of the body (102) can be steel, aluminum, metal, elastomer, a corrugated material, a plastically deformable material, or a combination thereof. In some embodiments, the flexible material of the body (102) is steel. In further embodiments, the steel is a thin gauge steel, a pre-galvanized steel, or a commercial grade steel. In some embodiments, the flexible material of the body (102) is metal or a conductive metal. In some embodiments, the flexible material of the body (102) is an elastomer. In some embodiments, the elastomer is a natural or synthetic polymer. In some embodiments, the natural or synthetic polymer may have elastic properties. In some embodiments, the elastomer is bonded to a metal strip or a thin metal strip. In some embodiments, the elastomer may provide improved flexibility or a softer surface to protect the wires of a wire management system, while the metal strip may provide the ground path. It is to be understood that the flexible material of the body (102) allows for slight misalignment between adjacent photovoltaic module arrangements, thus allowing for differential movement (e.g., due to wind or other external forces) in all three axis, x, y, and z, without fatigue or failure of the ground path connector (100).

In further non-limiting embodiments of the present disclosure, the body (102) may further include a middle portion (112) as illustrated in FIGS. 1A-2C. In some embodiments, the middle portion (112) is between the first attachment portion (104) and the second attachment portion (108). In some embodiments, and as illustrated in FIGS. 1C and 2B, the middle portion (112) can be offset on a horizontal axis from the first attachment portion (104) and the second attachment portion (108). In some embodiments, the middle portion (112) may include one or more holes (114) such that the one or more holes (114) can be configured for a wire management system such that the ground path connector (100) provides protection of a cable bundle against the edges of beams of each photovoltaic module arrangement (302). In some embodiments, the middle portion (112) may include two or more holes, three or more holes, four or more holes, five or more holes, or six or more holes.

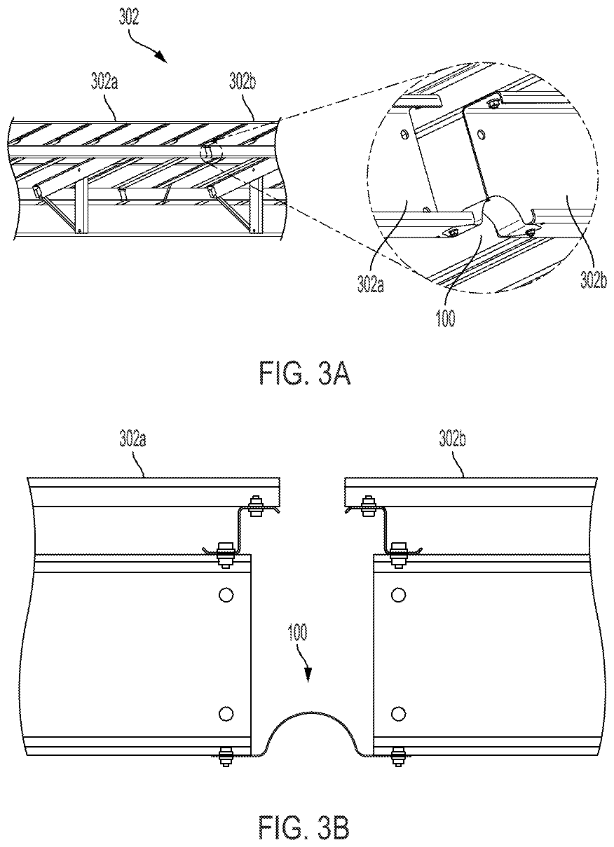

In some embodiments of the present disclosure, the first attachment portion (104) or the second attachment portion (108) may include one or more holes (116) as illustrated in FIGS. 1A-2C. In some embodiments, the one or more holes (116) of the first attachment portion (104) or the second attachment portion (108) can be configured to attach to a photovoltaic module arrangement (302) as illustrated in FIGS. 3A-3C. In some embodiments, the one or more holes (116) of the first attachment portion (104) can be configured to attach to a first photovoltaic module arrangement (302a). In some embodiments, the one or more holes (116) of the second attachment portion (108) can be configured to attach to a second photovoltaic module arrangement (302b). In some embodiments, and as illustrated in FIGS. 3A and 3B, the one or more holes (116) of the first attachment portion (104) can be configured to attach to the first photovoltaic module arrangement (302a), and the one or more holes (116) of the second attachment portion (108) can be configured to attach to the second photovoltaic module arrangement (302b).

The present disclosure further relates to a photovoltaic module system, generally depicted at FIGS. 3A and 3B. In some embodiments, the photovoltaic module system may include a first photovoltaic module arrangement (302a), a second photovoltaic module arrangement (302b), and a ground path connector (100). In some embodiments, the ground path connector (100) may include a body (102), a first attachment portion (104) provided on a first end (106) of the body (102), and a second attachment portion (108) provided on a second end (110) of the body (102). In some embodiments, the second end (110) of the body (102) may oppose the first end (106) of the body (102). In some embodiments, the body (102) can be made of a substantially flexible material as described hereinabove. In further embodiments, the first attachment portion (104) can be configured to attach to the first photovoltaic module arrangement (302a), and the second attachment portion (108) can be configured to attach to the second photovoltaic module arrangement (302b).

While aspects of the ground path connector are shown in the accompanying figures and described hereinabove in detail, other aspects will be apparent to, and readily made by, those skilled in the art without departing from the scope and spirit of the invention. Accordingly, the foregoing description is intended to be illustrative rather than restrictive. The invention described hereinabove is defined by the appended claims and all changes to the invention that fall within the meaning and the range of equivalency of the claims are to be embraced within their scope.

It is worthy to note that any reference to “one embodiment” or “an embodiment” means that a particular feature, structure, or characteristic described in connection with the embodiment is included in at least one embodiment. Thus, appearances of the phrases “in one embodiment” or “in an embodiment” in various places throughout the specification are not necessarily all referring to the same embodiment. Furthermore, the particular features, structures, or characteristics may be combined in any suitable manner in one or more embodiments.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

With respect to the use of any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other different components. It is to be understood that such depicted architectures are merely exemplary, and that, in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include, but are not limited to, physically mateable and/or physically interacting components, and/or wirelessly interactable, and/or wirelessly interacting components, and/or logically interacting, and/or logically interactable components.

Some aspects may be described using the expression “coupled” and “connected” along with their derivatives. It should be understood that these terms are not intended as synonyms for each other. For example, some aspects may be described using the term “connected” to indicate that two or more elements are in direct physical or electrical contact with each other. In another example, some aspects may be described using the term “coupled” to indicate that two or more elements are in direct physical or electrical contact. The term “coupled”, however, also may mean that two or more elements are not in direct contact with each other, but yet still co-operate or interact with each other.

In some instances, one or more components may be referred to herein as “configured to”, “operative”, “adapted”, etc. Those skilled in the art will recognize that “configured to” can generally encompass active-state components, and/or inactive-state components, and/or standby-state components, unless context requires otherwise.

While particular aspects of the subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least”, the term “includes” should be interpreted as “includes but is not limited to”, etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations”, without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

In summary, numerous benefits have been described which result from employing the concepts described herein. The foregoing disclosure has been presented for purposes of illustration and description. It is not intended to be exhaustive or limiting to the precise form disclosed. Modifications or variations are possible in light of the above teachings. It is intended that the claims submitted herewith define the overall scope of the present disclosure.

The invention claimed is:

1. A ground path connector for a photovoltaic module system, the ground path connector comprising:
a body;
a first attachment portion provided on a first end of the body; and
a second attachment portion provided on a second end of the body, the second end of the body opposing the first end of the body,
wherein at least the body is made of a substantially flexible material, and
wherein the first attachment portion is configured to attach to a first photovoltaic module arrangement and the second attachment portion is configured to attach to a second photovoltaic module arrangement.

2. The ground path connector of claim 1, wherein the body is a radiused shape.

3. The ground path connector of claim 2, wherein the radiused shape is a round radius, a W-shaped contour, a U-shaped contour, an omega-shaped contour, or a combination thereof.

4. The ground path connector of claim 1, wherein the first attachment portion or the second attachment portion is substantially round.

5. The ground path connector of claim 1, wherein the body comprises a middle portion between the first attachment portion and the second attachment portion.

6. The ground path connector of claim 5, wherein the middle portion is offset on a horizontal axis from the first attachment portion and the second attachment portion.

7. The ground path connector of claim 5, wherein the middle portion comprises one or more holes configured for a wire management system.

8. The ground path connector of claim 1, wherein the first attachment portion or the second attachment portion comprises one or more holes for attaching to the first photovoltaic arrangement and the second photovoltaic arrangement, respectively.

9. The ground path connector of claim 1, wherein the flexible material is selected from the group consisting of steel, aluminum, metal, elastomer, corrugated material, a plastically deformable material, and a combination thereof.

10. The ground path connector of claim 9, wherein the steel is thin gauge steel, a pre-galvanized steel, or a commercial grade steel.

11. The ground path connector of claim 9, wherein the metal is a conductive metal.

12. The ground path connector of claim 9, wherein the elastomer is a natural or synthetic polymer having elastic properties.

13. The ground path connector of claim 9, wherein the elastomer is bonded to a metal strip, optionally a thin metal strip.

14. A photovoltaic module system, comprising:
a first photovoltaic module arrangement;
a second photovoltaic module arrangement; and
a ground path connector, the ground path connector comprising:
a body;
a first attachment portion provided on a first end of the body; and
a second attachment portion provided on a second end of the body, the second end of the body opposing the first end of the body,
wherein at least the body is made of a substantially flexible material, and
wherein the first attachment portion is configured to attach to the first photovoltaic module arrangement and the second attachment portion is configured to attach to the second photovoltaic module arrangement.

15. The photovoltaic module system of claim 14, wherein the body is a radiused shape.

16. The photovoltaic module system of claim 15, wherein the radiused shape is a round radius, a W-shaped contour, a U-shaped contour, an omega-shaped contour, or a combination thereof.

17. The photovoltaic module system of claim 14, wherein the first attachment portion or the second attachment portion is substantially round.

18. The photovoltaic module system of claim 14, wherein the body comprises a middle portion between the first attachment portion and the second attachment portion.

19. The photovoltaic module system of claim 18, wherein the middle portion is offset on a horizontal axis from the first attachment portion and the second attachment portion.

20. The photovoltaic module system of claim 18, wherein the middle portion comprises one or more holes configured for a wire management system.
